(19) United States
(12) Patent Application Publication
(10) Pub. No.: US 2024/0127264 A1
(43) Pub. Date: Apr. 18, 2024

(54) SYSTEMS, METHODS, AND DEVICES FOR AUTOMATED EMISSIONS DATA COLLECTION AND ANALYSIS

(71) Applicant: Tergo, LLC, Phoenix, AZ (US)

(72) Inventor: Thuy N. Nguyen, Gdynia (PL)

(21) Appl. No.: 18/393,049

(22) Filed: Dec. 21, 2023

Related U.S. Application Data
(63) Continuation-in-part of application No. 17/974,330, filed on Oct. 26, 2022.
Application No. 17/974,330 is a continuation-in-part of application No. 17/074,354, filed on Oct. 19, 2020, now Pat. No. 11,694,258.
Application No. 17/074,354 is a continuation-in-part of application No. 18/480,448, filed on Oct. 3, 2023.
(60) Provisional application No. 63/272,449, filed on Oct. 27, 2021.

(51) Int. Cl. G06Q 30/018

(52) U.S. Cl. CPC G06Q 30/018

(57) ABSTRACT

An example process collects supply-chain data of an entity. The supply-chain data comprises shipping data and manufacturing data of a product offered by the entity. A supply-chain emissions value of the product is calculated based on the shipping data and the manufacturing data of the product. A potential emissions value of the product can be estimated using potential shipping data and potential manufacturing data. The potential shipping data is generated based on a first potential policy change of the entity. The manufacturing data is based on a second potential policy change of the entity. A potential emissions reduction of the entity is calculated by subtracting the potential emissions value of the product from the supply-chain emissions value of the product. The supply-chain emissions value of the product, the potential emissions value, and the potential emissions reduction are ingested into a carbon accounting database accessible by the entity.

### CROSS-REFERENCE TO RELATED APPLICATIONS

This application claims priority to U.S. patent application Ser. No. 17/974,330 filed on Oct. 26, 2022 and entitled “SYSTEMS, METHODS, AND DEVICES FOR GENERATING CRYPTOCURRENCY BASED ON CARBON DIOXIDE EMISSIONS” and to U.S. Provisional Patent Application No. 63/272,449 filed on Oct. 27, 2021 and entitled “SYSTEMS, METHODS, AND DEVICES FOR GENERATING CRYPTOCURRENCY BASED ON CARBON DIOXIDE EMISSIONS” and to U.S. patent application Ser. No. 17/074,354 filed on Oct. 19, 2020 and entitled “SYSTEMS, METHODS, AND DEVICES FOR GENERATING AND TRADING ENVIRONMENTAL CREDITS.” This application also claims priority to U.S. patent application Ser. No. 18/480,448 filed on Oct. 3, 2023 and entitled “SYSTEMS, METHODS, AND DEVICES FOR ASSESSING MEETING EMISSIONS.” Each of the foregoing related applications are incorporated herein by reference.

### FIELD

The present application relates to automatically monitoring and tracking carbon emissions.

### BACKGROUND

Human behavior impact on the environment is sometimes quantified in terms of carbon footprint. An entity's carbon footprint may be described as the amount of carbon dioxide produced by that entity's activities and the activities of associated individuals. Entities can expand or reduce their carbon footprint by making behavioral decisions that increase or reduce carbon dioxide generation directly and indirectly. However, most entities lack a quantitative sense of how their decisions impact the environment. Even entities that do understand their ever-changing carbon footprint still might lack a meaningful incentive to behave in a more environmentally friendly manner and reduce their carbon footprint.

Corporate behavior is trending towards more socially and environmentally conscientious decisions as investors and the public become more sensitive to social and environmental issues. Companies often seek out environmentally friendly activities and investments that deviate from their core competencies. For example, a datacenter might create solar fields and wind farms generating electricity from alternative fuel sources to offset their electricity consumption. In another example, vendors may contract with shipping companies that use more ecologically sound methods of transportation. The availability of eco-friendly behaviors for companies remains limited, and companies have little to no way to incentivize, analyze, or report on their carbon footprints.

### SUMMARY

Various embodiments automate collection, analysis, and accounting of environmental data. An example process for execution by a computer-based system may collect supply-chain data of an entity. The supply-chain data comprises shipping data and manufacturing data of a product offered by the entity. A supply-chain emissions value of the product is calculated based on the shipping data and the manufacturing data of the product. A potential emissions value of the product can be estimated using potential shipping data and potential manufacturing data. The potential shipping data is generated based on a first potential policy change of the entity. The manufacturing data is based on a second potential policy change of the entity. A potential emissions reduction of the entity is calculated by subtracting the potential emissions value of the product from the supply-chain emissions value of the product. The supply-chain emissions value of the product, the potential emissions value, and the potential emissions reduction are ingested into a carbon accounting database accessible by the entity.

In various embodiments, a carbon emissions report is generated for the entity. The carbon emissions report can include the supply-chain emissions value of the product, the potential emissions value of the product, and the potential emissions reduction. An emissions interface may be hosted and may include a graphical representation of actual emissions values from a plurality of products offered by the entity. A plurality products are aggregated into a group comprising a grouped supply-chain emissions value, a grouped potential emissions value, and a grouped potential emissions reduction over a predetermined period. Example processes can include hosting an emissions interface comprising a graphical representation of the group including the grouped supply-chain emissions value, the grouped potential emissions value, and the grouped potential emissions reduction over the predetermined period. The carbon accounting database may include scope 1 emissions data and scope 2 emissions data associated with the entity. Various embodiments host a reporting interface to selectively generate an emissions report comprising the scope 1 emissions data, the scope 2 emissions data, and the supply-chain emissions value.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the illustrations.

FIG. 1 illustrates a system for tracking activity various activities having an ecological impact, in accordance with various embodiments;

FIG. 2 illustrates a process for capturing data related to activities having an ecological impact, in accordance with various embodiments;

FIG. 3A illustrates a process for capturing data related to transportation activities, in accordance with various embodiments;

FIG. 3B illustrates a process for capturing data related to event activities, in accordance with various embodiments;

FIG. 3C illustrates a process for capturing data related to food activities, in accordance with various embodiments;

FIG. 3D illustrates a process for capturing data related to general transportation activities, in accordance with various embodiments;

FIG. 3E illustrates a process for capturing data related to general activities, in accordance with various embodiments;

FIG. 3F illustrates a process for capturing data related to user activities from third-party data sources, in accordance with various embodiments;

FIG. 3G illustrates a process for capturing data related to meeting activities, in accordance with various embodiments;

FIG. 3H illustrates a process for capturing data related to supply chain activities, in accordance with various embodiments;

FIG. 4 illustrate an example of an emissions-accounting interface, in accordance with various embodiments;

FIGS. 5A-5B illustrate an example of an emissions-reporting interface, in accordance with various embodiments; and

FIG. 6 illustrates an example process for assessing emissions associated with an entity, in accordance with various embodiments.

### DETAILED DESCRIPTION

The detailed description of exemplary embodiments herein refers to the accompanying drawings, which show exemplary embodiments by way of illustration and their best mode. While these exemplary embodiments are described in sufficient detail to enable those skilled in the art to practice the inventions, it should be understood that other embodiments may be realized, and that logical and mechanical changes may be made without departing from the spirit and scope of the inventions. The detailed description herein is thus presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step.

Systems, methods, and devices of the present disclosure (collectively, the “System”) may operate using a web app, mobile app, tablet, wearable, personal computer, wearable, or other device to collect data relating to the ecological impact of activities that contribute to an entity's carbon footprint. The System may collect data, analyze, compute and track an individual, products, services, actions, events, groups and use the data to generate real-time, instantaneous measurement of carbon-dioxide emissions or other suitable measurement for environmental impact. Results may take the form of an instant CO2 emission calculation or an instant CO2 emission saving calculator, for example. The data and results of analysis can be stored in carbon accounting software for further analysis, reporting, or other access.

The System may track CO2 emission caused by actions, products used, services used, related individuals, or other activity relative to a baseline value. CO2 emissions savings can also be calculated by comparing the CO2 emissions to a baseline value. For example, a corporation's emissions or emissions savings can be compared to emissions of competing entities engaged in the same or similar lines of business. In another example, a corporation's emissions or emissions savings can be compared to emissions of all tracked entities. Some embodiments can verify emissions data associated with entities. The System can generate reports, simulations, or strategic reduction plans tailored to an entity based on associated emissions data. An entity's emissions and emissions savings data, along with relevant comparisons, can be used for further analysis and reporting related to the entity's CO2 emissions.

The System can aggregate data pertaining to actions of individuals associated with entities and analyze how the actions of individuals are affecting emissions of broader entities or collections of individuals. The System can analyze decisions made and how recommend alternative choices that can impact an entities emissions, giving entities road maps to cleaner operations. The analysis is performed on data that can be automatically collected across supply chains, value chains, operations associated with the entity, and individuals associated with the entity using applications, embedded software, and interfaces into third-party data sources. The data collected and resulting analysis can be integrated into reports, reduction plans, simulations, rankings, universal access to all entities, strategies, analysis, compliance, regulation fulfillment/compliance, or other outputs.

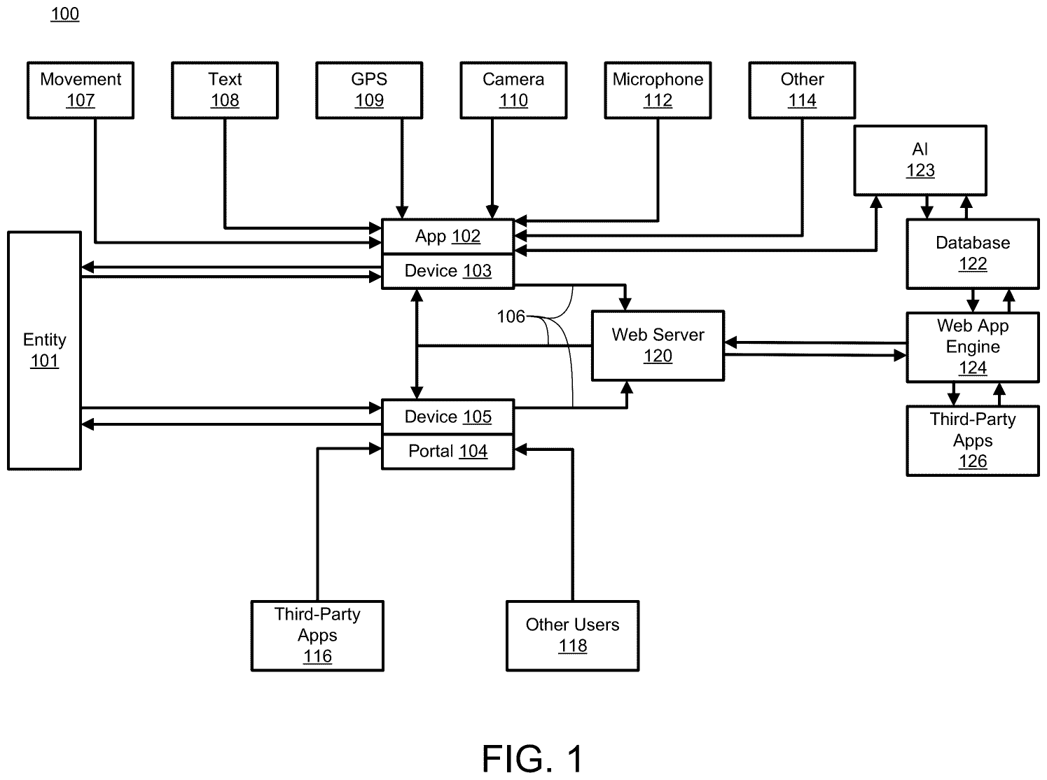

Referring now to FIG. 1, an exemplary system 100 is shown for collecting data reflecting the ecological impact of various activities, in accordance with various embodiments. Entity 101 and associated users may interact with system 100 through app 102 running on computing device 103 and/or a web portal 104 running on computing device 105. The users may be affiliated with an entity such that some of their actions are attributable to the carbon footprint of the entity. A computing device may include active components that detect the state of the environment surrounding computing device 103 such as, for example, movement sensor 107 (e.g., an accelerometer), a GPS sensor 109, microphone 112, camera 110, biometric scanner, or other component 114 suitable for detecting state. Device 103 may also accept user input in the form of typed text or spoken word using a text interface 108 such as, for example, keyboard, touchscreen, voice-to-text interface, or other suitable input/output device. Third-party apps 116 and other users 118 may also interact with portal 104 to submit or retrieve information related to user or entity behavior.

In various embodiments, app 102 may comprise a web app, native app, operating system, website, or other program capable of running on computing device 103. Application 102 and/or other programs running on computing devices may include programs written in a programming language such as, for example, Go, NODE.JS®, JAVA®, KOTLIN®, Python. Solidity, or any other programming language.

In various embodiments, computing devices referenced herein may include a processor and storage component. Computing devices may include or interface with one or more interface devices for input or output such as a keyboard, mouse, track ball, touch pad, touch screen, and/or display. A computing device may also include non-transitory memory in electronic communication with the processor. The memory may store instructions that, when executed by the processor, cause the processor to perform operations. A processor may include one or more microprocessors, co-processors, logic devices, and/or the like. A processor may comprise multiple microprocessors may execute in parallel or asynchronously. A logic device may include, for example, analog-to-digital converters, digital-to-analog converters, buffers, multiplexers, clock circuits, or any other peripheral devices required for operation of the processor. Memory may include a single memory device or multiple memory devices and may be volatile memory, non-volatile memory, or a combination thereof.

In various embodiments, a computing device may also comprise a storage interface in electronic communication with the processor. The storage interface may be configured to provide a physical connection to the storage component. For example, in response to a storage component comprising an internal hard drive or solid-state drive, a storage interface may include, for example, appropriate cables, drivers, and the like to enable the physical connection. As a further example, in response to the storage component comprising a removable storage medium, such as a CD-ROM drive, DVD-ROM drive, USB drive, memory card, and the like, the storage interface may comprise an interface, a port, a drive, or the like configured to receive the removable storage medium and any additional hardware and/or software suitable for operating the interface, the port, the drive, or the like.

In various embodiments, a computing device may also comprise a communication interface in electronic communication with the processor. A communication interface may be, for example, a serial communication port, a parallel communication port, an Ethernet communication port, or the like. A computing device may comprise a communication medium configured to enable electronic communication between a computing device and a network 106. A communication medium may include a cable such as an Ethernet cable.

In various embodiments, a communication interface may be configured for wireless communication via infrared, radio frequency (RF), optical, BLUETOOTH®, cellular, or other suitable electromagnetic and/or wireless communication methods. A communication interface may comprise one or more antennas configured to enable communication over free space. A network suitable for passing communication between computing devices may be, for example, an intranet, the Internet, an internet protocol network, or a combination thereof. Each computing device of system 100 may communicate with another computing device either directly or indirectly via the network.

In various embodiments, computing devices of system 100 may be configured to execute an application such as app 102, web server 120, portal 104, web app engine 124, database 122, artificial intelligence 123 (AI), or third-party apps 126, for example, as well as an operating system suitable for operating the computing device. The operating system may manage resources of the computing and provides common services between applications executing on the processor of a computing device. The operating system may be stored on a storage component, within memory, or on a combination thereof. Operating systems may vary between computing devices and may be configured to control the hardware components for the associated computing device.

In various embodiments, computing device 103 and computing device 105 may be in communication with web server 120 over network 106. Web server 120 may serve as the interface for app 102 and/or portal 104 to read and write user data and deliver emissions information to Entity 101 and associated users by transmitting data using HTTP across network 106. Web server 120 may be a commonly available web server such as Apache®, for example, running on a dedicated computing device. Web server 120 may also be a hosted web server service such as, for example, Azure® or AWS® running on a cluster of computing devices.

In various embodiments, web server 120 may be in communication with web app engine 124. Web app engine 124 may read and write user data, analytics, and entity information to database 122. Web app engine may also serve and/or receive data from third-party apps 126. Web app engine 124 may process data relating to behavior of entity 101 and associated users captured by app 102 and/or portal 104 to generate analysis based on the various activities performed by entity 101.

In various embodiments, AI 123 may interact with database 122 and the app 102. AI 123 may read and write data from database 122 to draw conclusions collected data and recorded outcomes to improve user experience. For example, AI 123 may detect that a user associated with entity 101 is using a bicycle frequently, so AI 123 may prompt the user in app 102 ‘Are you going to use a bicycle today’?′ to both encourage reduction of carbon emission. AI 123 may interact with app 102 by prompting a user with suggestions. For example, AI 123 may detect a user associated with entity 101 is spending unusually high amounts of time browsing in the app for options. AI 123 may prompt ‘How would you like to reduce your carbon emissions?’ The AI may thus use ‘real-time’ data derived from app 102 as an input to improve the experience of users associated with entities 101 in app 102.

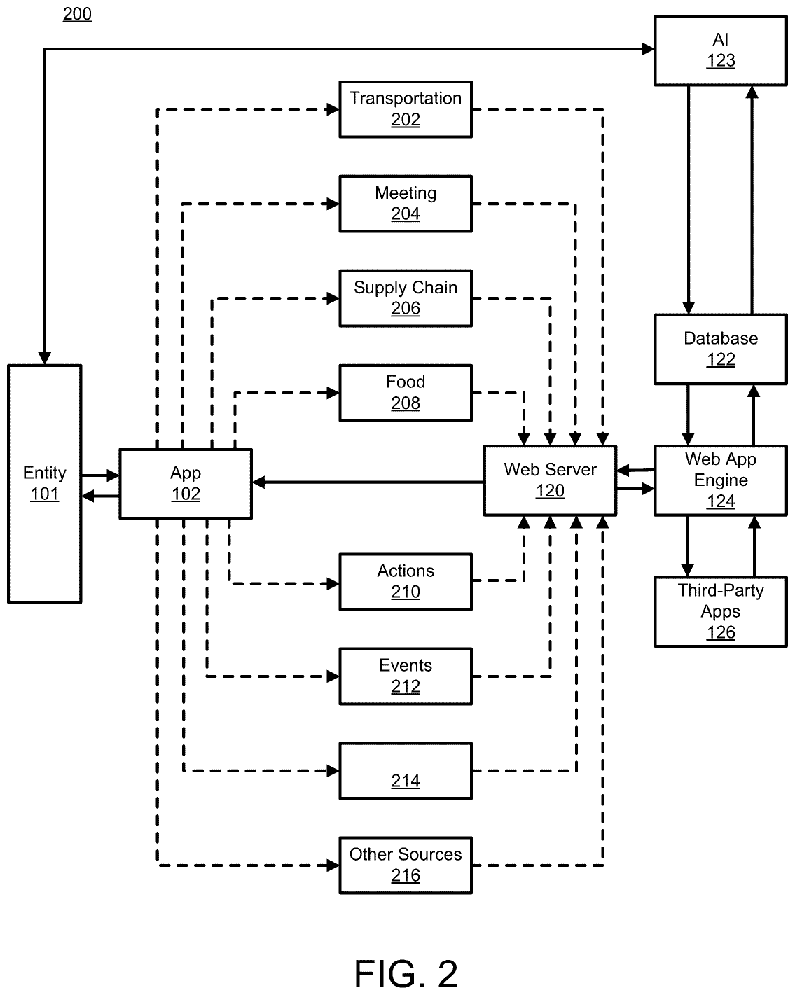

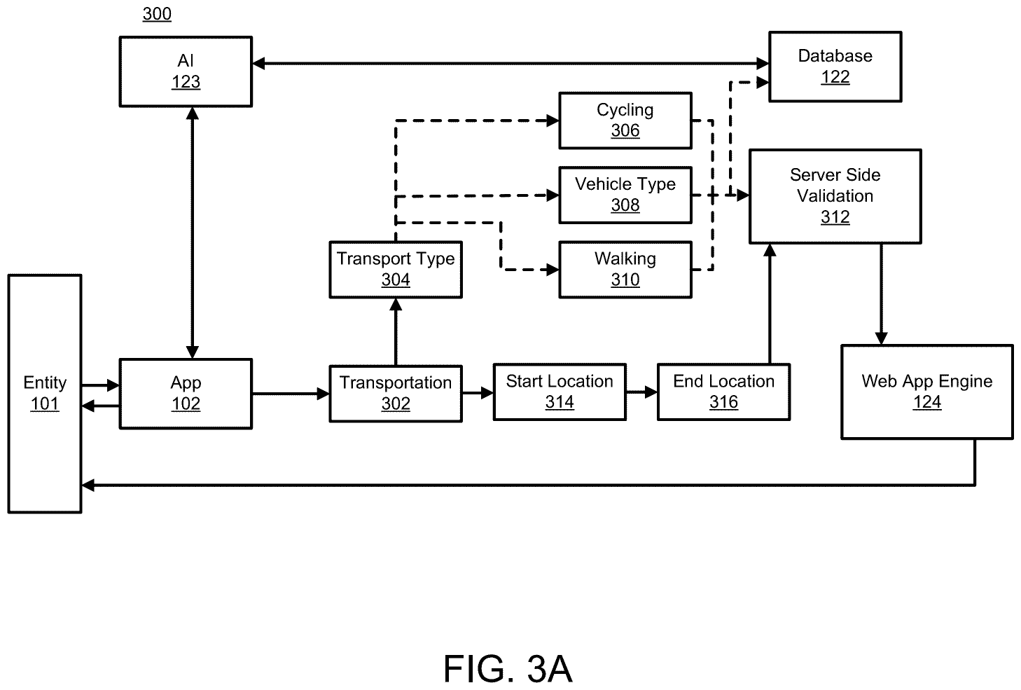

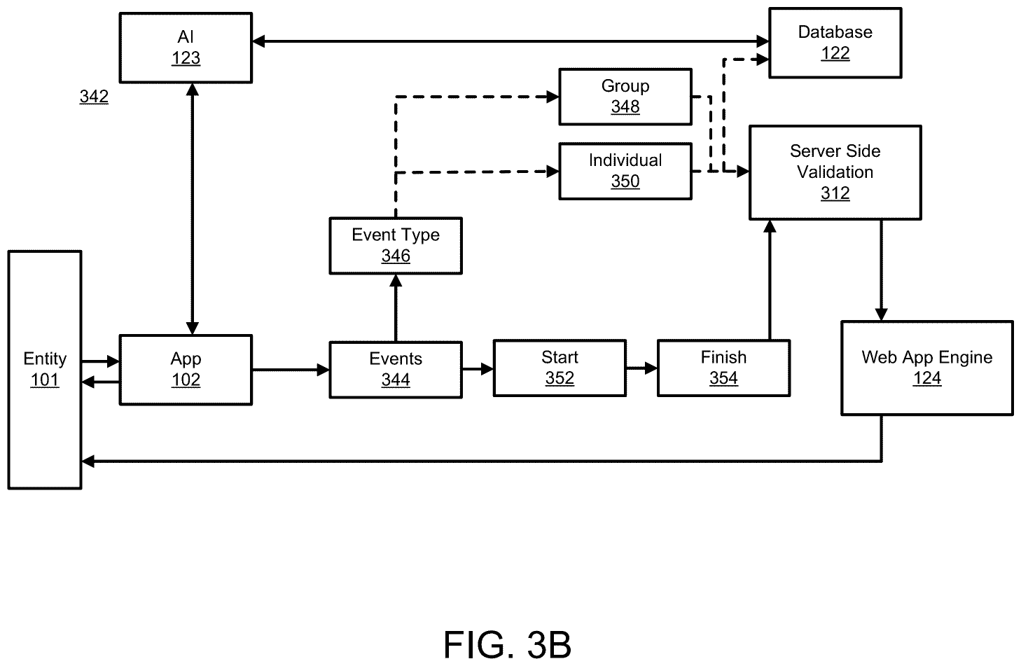

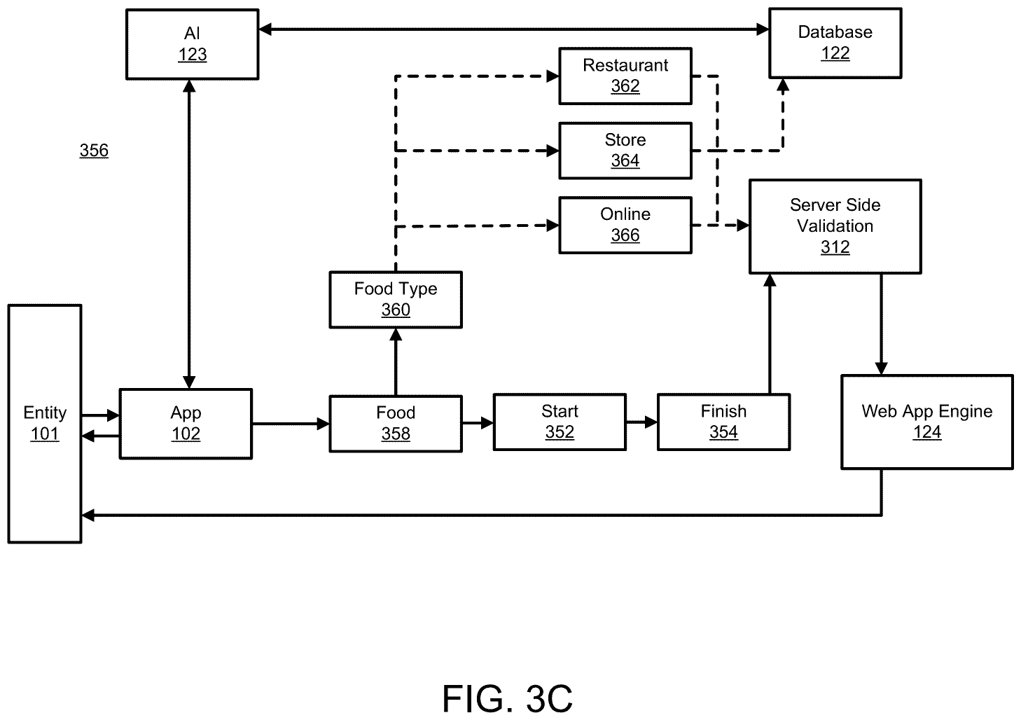

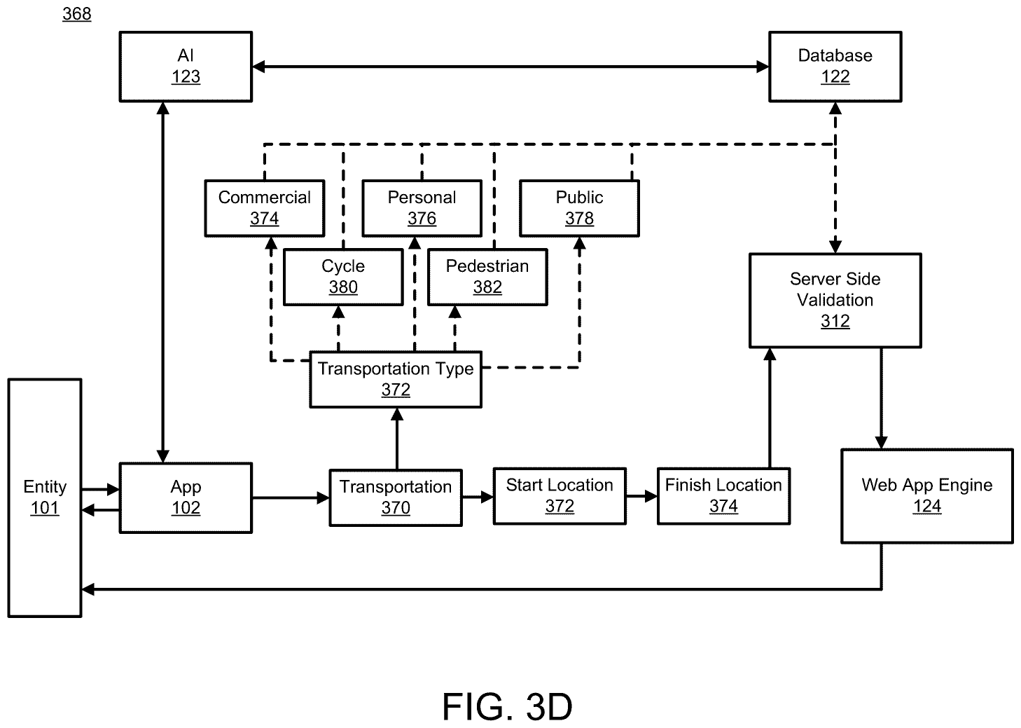

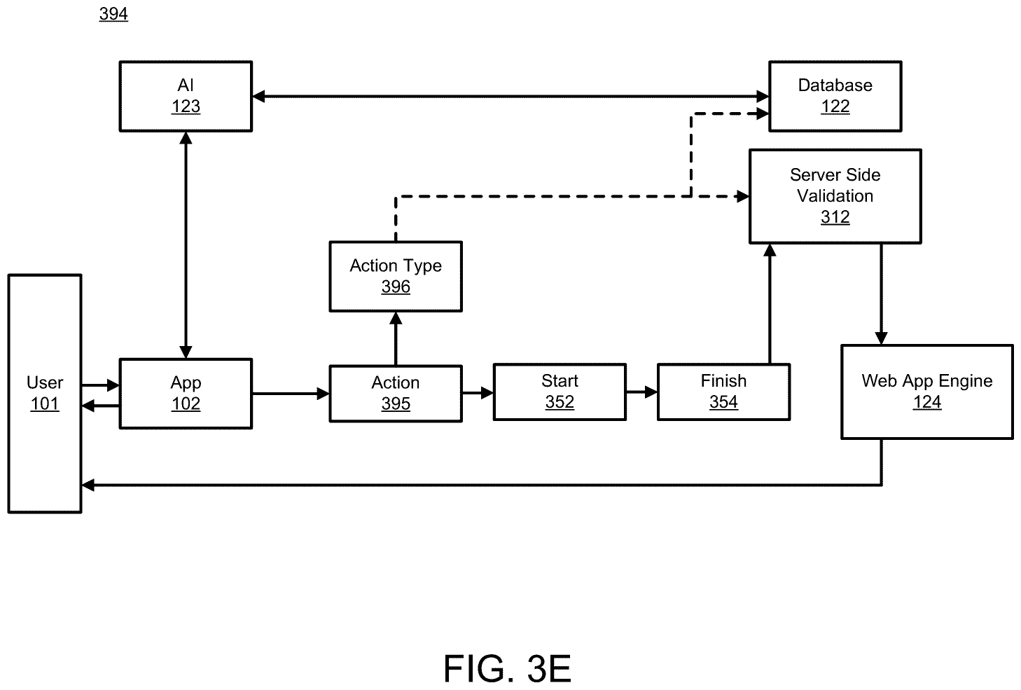

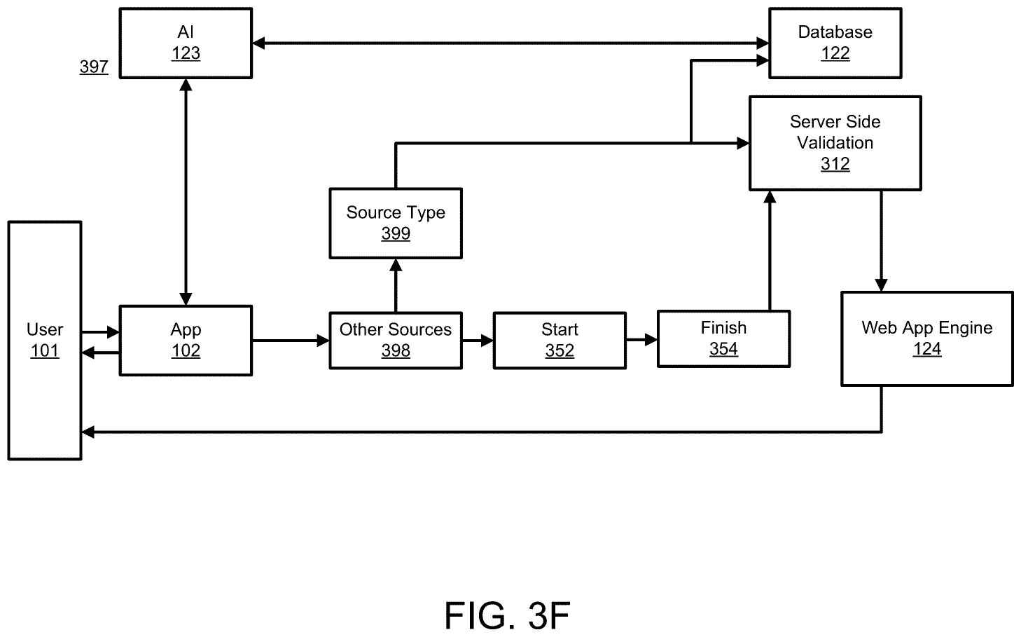

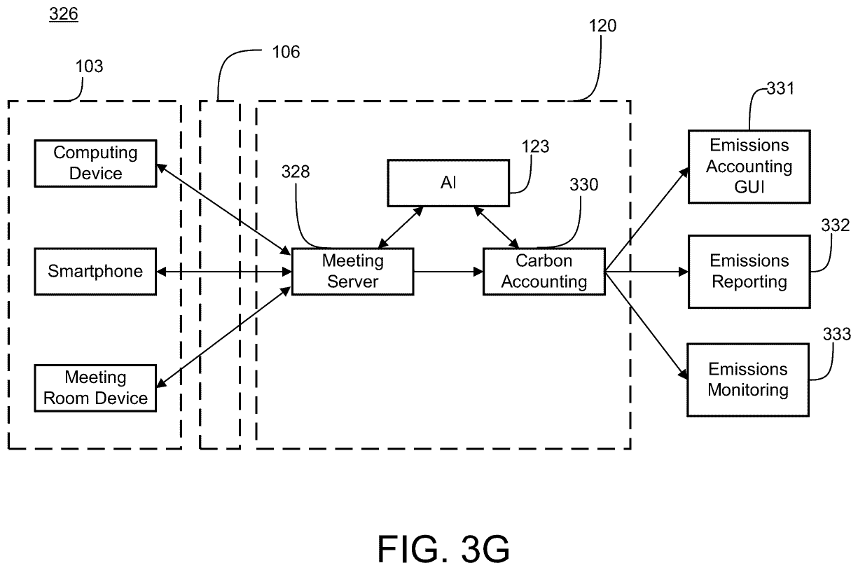

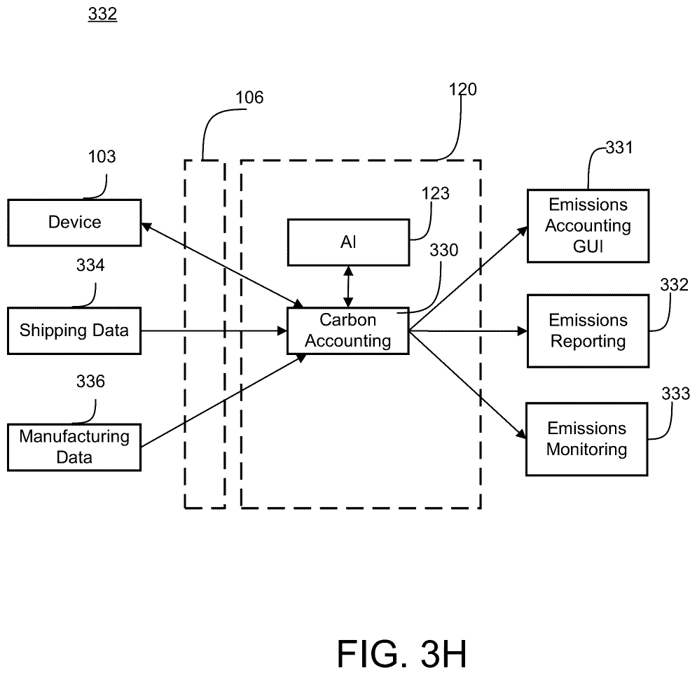

Referring now to FIG. 2, a system 200 for tracking and analyzing carbon emissions based on the environmental impact of activities associated with entities is shown, in accordance with various embodiments. App 102 running on computing device 103 (of FIG. 1) may collect and/or process data related to various activity categories having an environmental impact. For example, app 102 may collect and/or process transportation data 202, meeting data 204, supply chain data 206, food data 208, action data 210, event data 212, and/or other data sources 216. App 102 may transmit collected data and/or processing results via web server 120 to web app engine 124. FIGS. 3A to 31 depict examples of processes for app 102 to collect and/or process data related to the foregoing activity categories.

In various embodiments, web app engine 124 may assess the environmental impact of user activities in response to activity data received from app 102 and/or portal 104 to generate credits.

Referring now to FIG. 3A, system 300 is shown for collecting and processing transportation data 202 (of FIG. 2) for entity 101 and associated users of app 102, in accordance with various embodiments. App 102 running on computing device 103 (of FIG. 1) may detect a transportation event 302 in response to a user selecting transportation, detecting a location difference between two GPS inputs, detecting movement of computing device 103 (of FIG. 1), or otherwise determining that a user associated with entity 101 is moving during business hours, on a business trip, using an entity vehicle, involving an entity facility, or otherwise at the behest of entity 101.

In various embodiments, app 102 may categorize the transportation type 304 as cycling 306, auto type 308, walking 310, or other suitable transportation mediums. App 102 may categorize the transportation event 302 in response to the user selecting a category, matching a path of travel and/or rate of travel to a travel type, and/or prompting entity 101 or associated users user to confirm a category of transportation event 302.

In various embodiments, app 102 may transmit the transportation event 302, associated categories, and other associated data such as, for example, distance traveled, duration of travel, and path of travel to web server 120 (of FIG. 2), web app engine 124 (of FIG. 2), and/or database 122 for server-side validation 312 and analysis by AI 123. Server-side validation 312 may include calculating a trip distance and/or trip route using start location 314 and end location 316. Server-side validation 312 may include using a mapping utility that accepts start location 314 and end location 316 to generate a likely route traveled and distance traveled. Server-side validation 312 may also use start location 314 and end location 316 to calculate a straight-line distance between the two points. The distance and/or route traveled along with the categorizations from app 102 may be used by web app engine 124 to calculate emissions or emissions savings assignable to entity 101 in real-time. AI 123 may consider real-time data from app 102 and data written to database 122 to make user experience improvements.

In various embodiments, system 300 may use various factors and parameters to calculate, estimate, approximate, or otherwise generate CO2 emissions associated with a transportation event to assign a credit value to the transportation event. For example, the techniques identified in U.S. Pat. No. 11,694,258, which is incorporated herein by reference.

Referring now to FIG. 3B, system 342 is shown for collecting and processing event data 212 (of FIG. 2) for users associated with entity 101, in accordance with various embodiments. App 102 running on computing device 103 (of FIG. 1) may detect event 344 in response to a user selecting event in app 102, an event email confirmation, purchase data from a charge at an event, or other event data communicated to a user associated with entity 101, device 103 (of FIG. 1), data submitted from the event holder, or other data from another application running on a device 103 (of FIG. 1). Event 344 may include, for example, planting a tree, a tree consuming CO2 to produce O2, litter pickup, environmental cleaning, recycling, refurbishing devices, or other environmentally friendly events. An event may also include entity-wide events or environmental events associated with entity 102. App 102 may use natural language processing, operating system calls, or API calls, for example, to parse text and otherwise retrieve data from other applications running on computing device 103 (of FIG. 1).

In various embodiments, app 102 may categorize event 344 as having an event type 346, which may include, for example, individual 350 or group 348, or other data related to an event and relevant to the environmental impact of entity 101. Data related to an event may include the type of event, the audience in attendance at the event, the carbon footprint to host the event, or other data suitable to assess the environmental impact of entity 101 hosting or attending event 344.

In various embodiments, app 102 may capture start 352 data such as, for example, start location, start time, start temperature, start biometrics, start environmental condition, or other start conditions measured or entered at the start of event 344. App 102 may also capture end 354 data such as, for example, end location, end time, end temperature, end biometrics, end environmental condition, or other end conditions measured or entered at the end of event 344. Start 352 data may be compared to end 354 data to detect a difference or change in conditions such as, for example, duration, location, or environmental impact of event 344. App 102 may generate a summary 340 of event 344 for transmission to web server 120 (of FIG. 2), web app engine 124 (of FIG. 2), and/or database 122 for server-side validation 312 and analysis by AI 123. AI 123 may consider real-time data from app 102 and data written to database 122 to make user experience improvements.

Referring now to FIG. 3C, system 356 is shown for collecting and processing food data 208 (of FIG. 2) for entity 101 or associated users using app 102, in accordance with various embodiments. App 102 running on computing device 103 (of FIG. 1) may detect a food event 358 (i.e., a meal or food purchase) in response to a user selecting food 358, a food purchase using a virtual card installed on computing device 103 (of FIG. 1), an email receipt for a food purchase, purchase data from bank relating to a food event, or other food-related data associated with entity 101, users associated with entity 101, device 103 (of FIG. 1), and/or app 102 from a food vendor or third-party application running on device 103. App 102 may use natural language processing, operating system calls, or API calls to parse text and extract data from other applications running on computing device 103 (of FIG. 1). Catered food events may take into consideration the total amount of food purchased in comparison with the total number of people attending a catered food event in person.

In various embodiments, app 102 may categorize food type 360 of food event 358 as having an associated restaurant 362, physical store 364, online store 366, or other data related to food event 358 and relevant to the environmental impact of entity 101. Data related to food event 258 may include the type of food, an environmental rating of the vendor, the carbon footprint to produce and/or deliver the food, or other data suitable to assess the environmental impact of food event 358. Food events 358 may be aggregated to created larger food events spanning a greater period of time to assess food consumption, for example, over daily, weekly, monthly, or annual period. Consumption over daily, weekly, monthly, annual, or other periods can be evaluated for environmental impact.

In various embodiments, app 102 may capture start 352 data such as, for example, start location, start time, start temperature, start biometrics, or other start conditions measured or entered at the start of food event 358. App 102 may also capture end 354 data such as, for example, end location, end time, end temperature, end biometrics, or other end conditions measured or entered at the end of food event 358. Start 352 data may be compared to end 354 data to detect a difference or change in conditions such as, for example, an amount of food consumed or purchased over time or an amount of food waste after a catering event. App 102 may transmit data associated with food event 358 to web server 120 (of FIG. 2), web app engine 124 (of FIG. 2), and/or database 122 for server-side validation 312 and analysis by AI 123. AI 123 may consider real-time data from app 102 and data written to database 122 to make user experience improvements. Web app engine 124 may assess the environmental impact of food event 358.

Referring now to FIG. 3D, system 368 is shown for collecting and processing transportation data 202 (of FIG. 2) for entity 101 or associated users of app 102, in accordance with various embodiments. System 368 and system 300 (of FIG. 3A) may be used in tandem, interchangeably, alone, or not at all in various embodiments. App 102 running on computing device 103 (of FIG. 1) may detect a transportation event 370 in response to a user selecting transportation, detecting a location difference between two GPS inputs, detecting movement of computing device 103 (of FIG. 1), or otherwise determining that a user associated with entity 101 is moving. App 102 may categorize the transportation as commercial 374, personal 376, public 378, cycle 380, pedestrian 382, or other suitable transportation categories. App 102 may categorize the transportation event 370 in response to the user selecting a category, matching a path of travel and/or rate of travel to a travel type, and/or prompting entity 101 or associated users to confirm a category of transportation event 370. App 102 may also detect transportation events based on purchase data from connected accounts, virtual tickets on the same device 103, itinerary data sent to contact addresses associated with entity 101, or other sources associated with an entity 101.

In various embodiments, app 102 may transmit the transportation event 302, associated categories, and other associated data such as, for example, distance traveled, duration of travel, and path of travel to web server 120 (of FIG. 2), web app engine 124 (of FIG. 2), and/or database 122 for server-side validation 312 and analysis by AI 123. AI 123 may consider real-time data from app 102 and data written to database 122 to make user experience improvements. Server-side validation 312 may perform quality assurance checks. Web app engine 124 may calculate a trip distance and/or trip route using start location 372 and finish location 373. Web app engine 124 may use a mapping utility that accepts start location 372 and finish location 373 to generate a likely route traveled and distance traveled. Web app engine 124 may also use start location 314 and end location 316 to calculate a straight-line distance between the two points. For air fare, emissions data can be retrieved from the carrier for a particular flight number or flight route. The distance and/or route traveled along with the categorizations from app 102 may be used by web app engine 124 to calculate emissions, emissions savings, and other emissions data attributable to entity 101 and associated users.

With reference to FIG. 3E, system 394 is shown for collecting and processing action data 210 (of FIG. 2) for entity 101 or associated users of app 102, in accordance with various embodiments. App 102 running on computing device 103 (of FIG. 1) may detect an action event 395 in response to a user selecting action, detecting a purchase associated with an action, detecting mobile device 103 (of FIG. 1) in a location relevant to an action, or otherwise detecting data points relevant to actions of entity 101 and associated users. App 102 may categorize the action type 396 based on characteristics relevant to ecological impact of the actions of entity 101. App 102 may categorize the action event 395 in response to the user selecting a category and/or prompting entity 101 or associated users to confirm a category of action event 395. Action events may include, for example, repairs that improve efficiency, retrofits that improve energy efficiency, improvements that enhance efficiency, or other affirmative actions with a positive environmental impact at facilities associated with entity 101.

In various embodiments, app 102 may capture start 352 data such as, for example, start location, start time, start temperature, start biometrics, starting energy efficiency, or other start conditions measured or entered at the start of action event 395. App 102 may also capture end 354 data such as, for example, end location, end time, end temperature, end biometrics, end energy efficiency or other end conditions measured or entered at the end of action event 395. Start 352 data may be compared to end 354 data to detect a difference or change in conditions such as, for example, the environmental impact of an action event 395 over a period.

In various embodiments, app 102 may transmit action event 395, associated categories, and other associated data such as, for example, action performed, cumulative impact of action, or carbon impact associated with the action performed to web server 120 (of FIG. 2), web app engine 124 (of FIG. 2), and/or database 122 for server-side validation 312 and analysis by AI 123. AI 123 may consider real-time data from app 102 and data written to database 122 to make user experience improvements.

In one example, entity 101 can directly or indirectly generate and input their scope 1, scope 2, and scope 3 emissions data using techniques described herein. An entity can identify their scope 1 emissions data by identifying, measuring, and reporting direct greenhouse gas (GHG) emissions that result from their own activities or operations. Scope 1 emissions are those that are directly produced by the entity, and they typically include fuel combustion, process emissions, and mobile combustion, for example. An entity can upload data for carbon accounting server 330 or AI 123 to use emission factors to calculate the amount of greenhouse gases produced per unit of activity, though entity 101 can also perform the analysis and enter the data directly in various embodiments. Emission factors are coefficients that relate the quantity of emissions to a specific activity metric (e.g., kilograms of CO2 emitted per unit of energy consumed). In some embodiments, carbon accounting server 330 or AI 123 can perform third-party verification or assurance processes to ensure the accuracy and reliability of emissions data associated with entity 101 to enhance transparency and credibility.

An entity can identify their scope 2 emissions data by assessing and reporting indirect greenhouse gas (GHG) emissions associated with the generation of the electricity, heat, steam, or cooling they purchase from external sources. Scope 2 emissions are typically categorized as indirect emissions and are a significant part of an entity's overall carbon footprint. Emissions data can be collected and transmitted to web server 120 or carbon accounting server 330 using techniques described herein.

Collecting data on Scope 3 emissions can be a complex task for companies because these emissions are indirect and often result from activities outside the entity's operational boundaries. Scope 3 emissions cover a broad range of sources, including those associated with the supply chain, product life cycle, business travel, and other indirect activities. Scope 3 emissions categories include upstream and downstream emissions in the supply chain, business travel, employee commuting, use of sold products, waste generated, and other operational emissions not directly attributable to entity 101. In one example, meeting emissions data can be collected and categorized as scope 3 emissions data using addons for meeting software to collect meeting data 204. In another example, AI 123 or carbon accounting software 123 can use supply chain data 332 to associate entity 101 with other entities it uses for services. AI 123 or carbon accounting software 123 can estimate scope 3 emissions data for entity 101 based on the associated entity's emissions data and the amount of dealings entity 101 has with the associated entity.

Referring now to FIG. 3F, system 397 is shown for collecting and processing data from other sources 216 (of FIG. 2) for entity 101 using app 102, in accordance with various embodiments. App 102 running on computing device 103 (of FIG. 1) may detect data from other sources 398 in response to app 102 reading a communication with a third-party app, detecting a measurement from an internet source, receiving purchase transaction history associated with entity 101, using an API call, using an operating system call, or detecting communication from other sources 398 with mobile device 103. App 102 may categorize the source type 399 based on characteristics relevant to ecological impact of the actions associated with entity 101. For example, source type may be bank app, a food delivery app, a retail app, a shipping, an invoicing app, an Internet of Things (IoT) device, a subscription service, a charitable donation app, a social media platform, or other source for data relevant to ecological impact of entity 101. Other examples can include supply chain sources, logistics company sources, invoice sources, embedded device sources, customs sources, import/export sources, service providers, or other potential data sources related to production or consumption associated with entity 101. App 102 may categorize the source type 399 in response to the user selecting a category and/or prompting entity 101 to confirm a category of other sources 398.

In various embodiments, other sources 398 or app 102 may capture start 352 data such as, for example, start location, start time, start temperature, start biometrics, starting energy efficiency, or other start conditions measured or entered at the start of other source 398. Other source 398 or app 102 may also capture end 354 data such as, for example, end location, end time, end temperature, end biometrics, end energy efficiency or other end conditions measured or entered at the end of other source 398. Start 352 data may be compared to end 354 data to detect a difference or change in conditions such as, for example, the duration of other source 398.

In various embodiments, app 102 may transmit other data sources 398, associated categories, and other associated data such as, for example, data source type, data source name, authorization to interact with the data source, or carbon impact associated with the data received from other sources to web server 120 (of FIG. 2), web app engine 124 (of FIG. 2), and/or database 122 for server-side validation 312 and analysis by AI 123. AI 123 may consider real-time data from app 102 and data written to database 122 to make user experience improvements.

Referring now to FIG. 3G, system 326 is shown for collecting and processing meeting data 204 (of FIG. 2) for users associated with entity 101 (of FIG. 1), in accordance with various embodiments. Users interact with system 326 through a meeting application running on client devices 102. The meeting application can be any commercially available meeting software such as, for example, those offered under the trade names ZOOM and TEAMS. Client devices 103 can include computing devices, smartphones, meeting room devices, or other devices such as a smartwatch, laptop, tablet, infotainment system, television, meeting hubs, conference bridges, suitably equipped meeting rooms, or other online device capable of participating in a virtual meeting. In some examples, a client device 103 can support a single participant, though in other examples a single client device 102 can support multiple participants in the same location. The devices 102 will typically communicate over network 106 comprising a local-area network (LAN) or wide-area network (WAN) with web server 120. Web server 120 may be in communication with or comprise meeting servers 328, carbon accounting servers 330, and AI 123 to participate in virtual meetings or to read or write carbon accounting data to database 122 or other data stores. In that regard, web server 120, meeting server 328, carbon accounting server 330, and AI 123 can run on the same hardware, on separate hardware, on cloud-computing platforms, computing clusters, containers, virtual machines, or on any other configuration of computing software and hardware. Client devices 103 can monitor bandwidth usage through real or virtualized network interfaces or networking infrastructure.

In various embodiments, meeting server 328, AI 123, and carbon accounting server 330 can comprise one or more servers, a computing cluster, virtualized computing resources, cloud computing resources, or other computing resources suitable for hosting virtual meetings. Meeting server 328, AI 123, and carbon accounting server 330 can be hosted on the same device. AI augmentation performed by AI 123 can include machine learning (ML), adaptive learning, neural network, active learning, large language systems, or other suitable AI technologies to analyze and augment emissions data described herein. AI systems can generate business intelligence (BI) that is actionable by entity 101 or business actions that are automatically implemented. Servers described herein can operate with one or more processors, memory, or network interfaces. Servers can include permanent storage configured with storage data structures such as, for example, relational databases, unstructured data stores, data lakes, or other data structures suitable for storing and retrieving carbon accounting data.

In various embodiments, the meeting application running on client devices 102 can include plugins, scripts, user profiles, supporting applications, application programming interfaces (APIs), or other executable code to collect and store data associated with the user of client devices 102 and of associated entity 101. Relevant user data can include current location, home location, demographics, IP address, phone number, or other information useable to estimate total emissions, baseline emissions, or emissions savings, for virtual meetings. Client devices 102 can accept user input in the form of typed text or spoken word using a text interface such as, for example, keyboard, touchscreen, voice-to-text interface, or other suitable input/output devices. Third-party apps and other users may also interact with the meeting software to submit or retrieve information related to user behavior.

In various embodiments, the meeting application or supporting application can comprise a web app, native app, operating system, website, or other program capable of running on client devices device 102. The operating system may manage resources of the computing and provides common services between applications executing on the processor of a computing device. The operating system may be stored in a storage component, memory, or a combination thereof. Operating systems may vary between computing devices and may be configured to control the hardware components for the associated computing device. The meeting application and/or other programs running on client devices 102 may include programs written in a programming language such as, for example, Go, NODE.JS®, JAVA®, KOTLIN®, Solidity, or any other programming language.

In various embodiments, entity 101 can have partitioned resources on meeting server 328, carbon accounting server 330, or web server 120. The partitioned resources can be private instances of meeting rooms that are accessible to people associated with entity 101 or otherwise authorized by entity 101. Entity 101 can also control access to outputs from carbon accounting server 330 or web server 120 (of FIG. 1) including access to emissions accounting GUI 331, emissions reporting 332, emissions monitoring 333, or other outputs of carbon accounting server 330 as described below. While carbon accounting server 330, emissions accounting GUI 331, emissions reporting 332, and emissions monitoring 333 are depicted in system 326, these features are also made available to entities when based on data collected using other systems and techniques described herein.

In various embodiments, meeting server 328 can host meetings with multiple participants physically separated from one another. Each participant can set up a user profile associated with their user account, can log into the meeting application with a client device 102, and can participate in a virtual meeting. A plugin or other secondary application can estimate the total emissions, baseline emissions, and emissions saved by holding the meeting virtually rather than holding the meeting in person. Meeting server 328 can run the secondary application, or client devices 102 can run the secondary application, or carbon accounting server 330 can run the secondary application.

In various embodiments, an estimate is generated for the emissions cost of hosting a corresponding in-person meeting. The in-person estimate can be based on the location of client devices 102 participating in the meeting. Location can be determined based on the IP address of the respective client devices 102. Location can be determined using GPS. Location can be determined based on user data manually entered and associated with a user account or company account authenticated with meeting server 328.

With reference now to FIG. 3H, a system 332 for collecting and processing supply chain data 206 (of FIG. 2) is shown, in accordance with various embodiments. Supply chain data 206 can be transmitted to a server such as web server 120 or carbon accounting server 330 directly from computing devices 103.

Computing devices 103 in this example can include any computing device comprising a software, memory, and an input/output interface. For example, an electronic control unit or other onboard computer in a supply chain vehicle can function as a device 103. Device 103 typically runs application 102 capable of identifying the route taken, speed, weight, and vehicle type over network 106 to carbon accounting server 330. Techniques can be similar to those described above for ingesting transportation data. Device 103 can also comprise a computing device associated with an entity 101 that collects and submits supply chain emissions data to carbon accounting software 330 or web server 120. Supply chain emissions data collected and submitted can include shipping invoices, shipping documentation, customs documentation, order information, or other data ingestible from a computing device associated with entity 101. Shipping data 334 can thus be directly reported from vehicles involved in shipping activities associated with entity 101.

Shipping data 334 can also be sent to web server 120 or carbon accounting server 330 by third-party applications or APIs made available by shipping partners or other supply chain service providers. The APIs can enable entity 101 or carbon accounting server 330 to directly pull emissions data, mileage data, shipping mass or volume data, shipping distances and routes, travel modes, or other data relevant to supply chain emissions. Shipping data 334 can be used to determine or estimate, or can directly include, carbon emissions associated with the shipping activities of entity 101. Shipping data 334 can also be estimated based on averages or other approximations, number of loads, volume of parcels per load, number of parcels per load, number of parcels total, transportation and logistics data, or other relevant data to estimate the shipping emissions associated with activity of entity 101.

Other forms of supply chain data 332 can include manufacturing data 336 that can also be attributed entity 101 using system 332. For example, manufacturing emissions data 336 can be attributable to an entity 101. Manufacturing data 336 can thus include a number of units purchased or made by entity 101, manufacturing emissions per unit, estimated manufacturing emissions, or other data related to manufacturing emissions. Sources can include manufacturers, data repositories with industry-wide estimates, closest competitor data, manual entry, or other suitable data sources. Relevant manufacturing emissions data 336 can include energy consumption data, material extraction and processing data, production process data, emissions factors, transportation and logistics of raw materials, waste generation and disposal, water usage, chemical usage, other resources usage, equipment efficiency, or other manufacturing data points relevant to supply chain data 332 of entity 101.

Examples of sources for supply chain data 336 may include utility bills, energy meters, data from energy suppliers, supplier data, life cycle analysis databases, industry reports, internal production records, equipment specifications, industry benchmarks, environmental agencies, emission factor databases, industry publications, shipping and logistics records, transportation companies, fuel consumption data, waste management records, disposal facility data, industry reports, utility bills, material safety data sheets, supplier information, employee surveys, transportation surveys, local transportation authorities, renewable energy certificates, carbon credits, equipment logs, maintenance records, manufacturer specifications, or other sources that generate data relevant to supply chain data 332 of entity 101. Data sources can be accessed using APIs, data exports from the above sources, ingestion into big data systems, manual entry, third-party applications associated with entity 101, or other suitable techniques.

AI 123 can ingest supply chain data 336 and shipping data 334 from the various data sources and perform analysis to estimate or calculate supply chain emissions 332 of entity 101. AI 123 can process supply chain data 332 as described above with reference to other data types. Resulting analysis and BI can be delivered to users associated with entity 101 through web server 120. Entity 101 can also control access to outputs from carbon accounting server 330 or web server 120 (of FIG. 1) including access to emissions accounting GUI 331, emissions reporting 332, emissions monitoring 333, or other outputs of carbon accounting server 330 as described below.

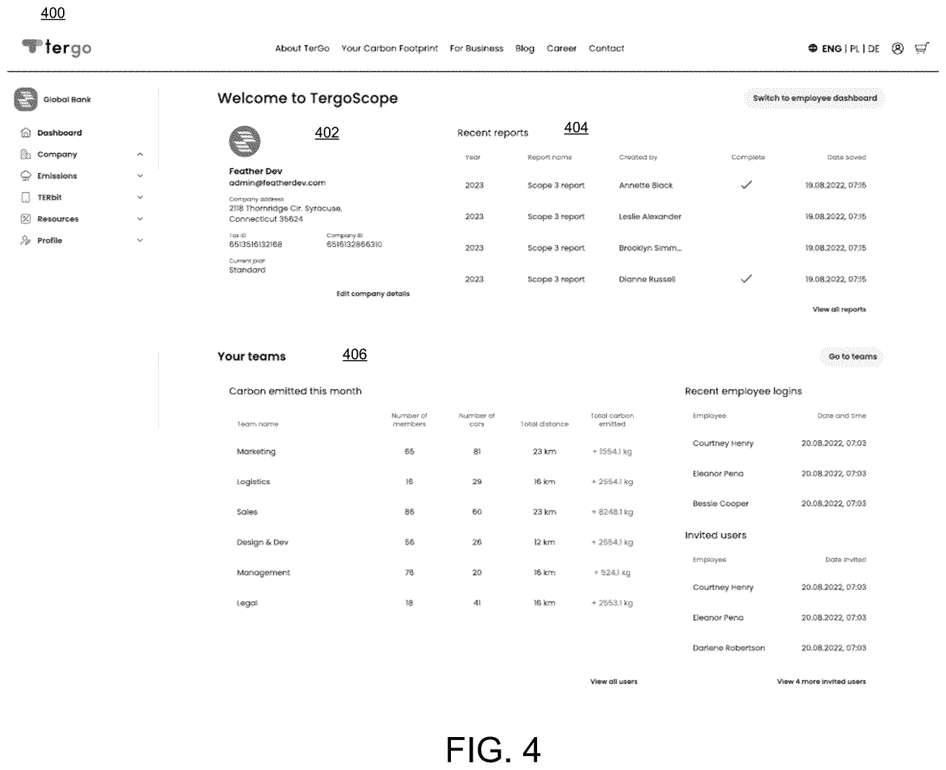

Referring now to FIG. 4, an emissions-accounting interface 400 is shown, in accordance with various embodiments. Interface 400 can include account information 402 for the authenticated user account accessing interface 400. For example, account information 402 can include username, account identifier (ID), company name, company address, tax identification, company identification, plan status, or other company or user details. Interface 400 can include data visualization tools such as, for example, report history 404. Report history 404 can include an index of reports run and can display report parameters such as, for example, report period, report name, report creator, request date and time, and report status.

In various embodiments, interface 400 may include company-wide emissions 406 detailing carbon emissions across the entity 101 by various groupings. Users associated with entity 101 can be grouped by team, by individual, by home facility, by home region, or other grouping suitable to assess entity-wide carbon emissions. Company-wide emissions 406 can aggregate and display emissions data for the groupings along with a grouping ID. Suitable emissions data for aggregation and display can include the number of individuals in the grouping (e.g., team members), the number of cars owned by or assigned to the grouping, the total distance to the work facility of the grouping, and the total carbon emitted from the grouping. Emissions data can include meeting emissions data, or other emissions data not directly related to meetings. For examples of emissions data suitable for integration into carbon accounting systems described herein, see U.S. Pat. No. 11,694,258, which is incorporated herein by reference for any purpose.

In various embodiments, emissions-accounting interface 400 can also include yearly, monthly, daily, hourly, seasonal, quarterly, regional, or location-based summaries. A yearly meeting summary, for example, may include visual representations of emissions attributable to entity 101 (e.g., line graphs or other graphical representations). Grouping data can be aggregated and normalized based on the size of a group (e.g., per capita numbers for groupings).

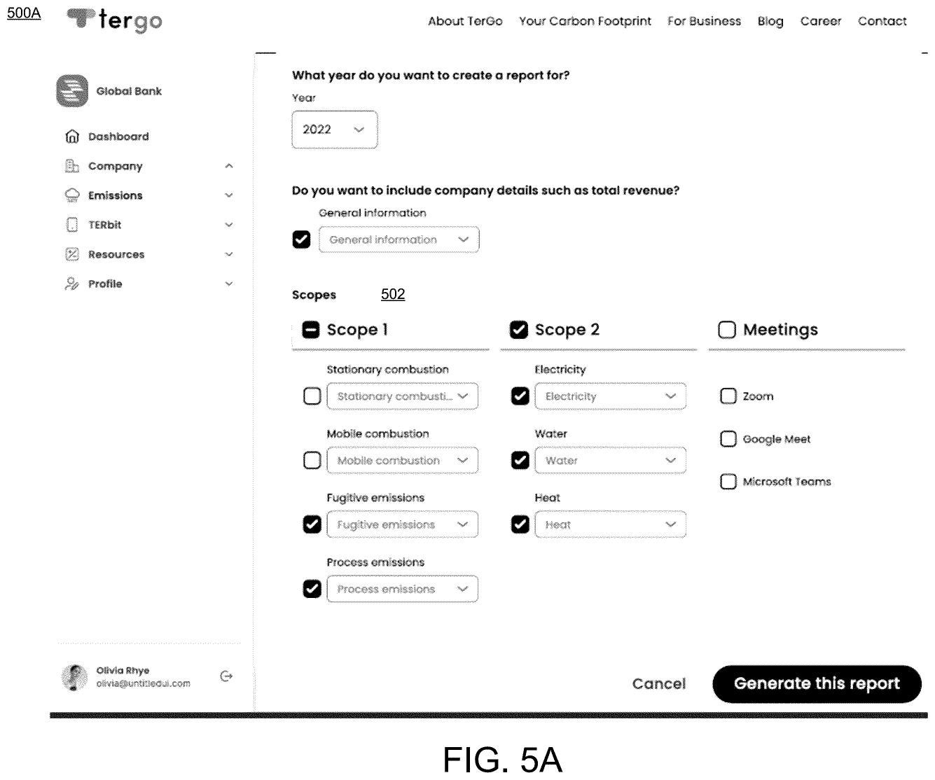

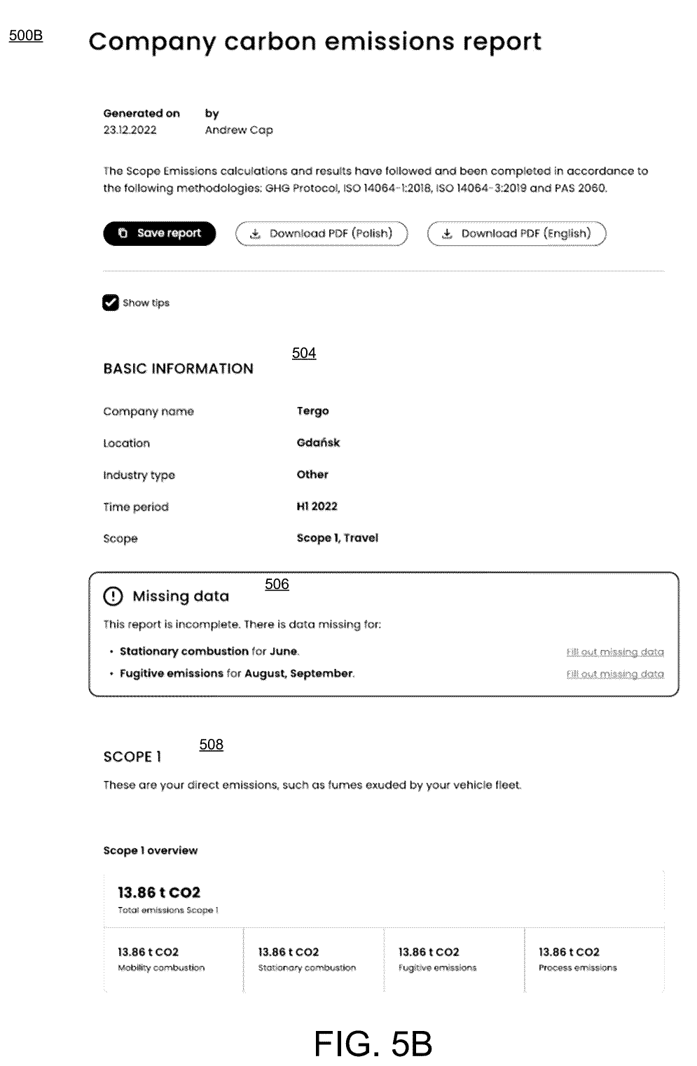

Referring now to FIGS. 5A and 5B, a reporting interface 500 is shown, in accordance with various embodiments. The example of FIG. 5A shows a report generation interface 500A. Interface 500A can be used to generate emissions reports for entity 101. Interface 500A can configure reports for a reporting period (e.g., a year, month, between start and end dates, compliance period, or another suitable period). Interface 500A can be configured to include company data or user data in the output reports. Scope 502 of the report can be set to include scope 1 emissions, scope 2 emissions, scope 3 emissions, meeting emissions, or other types of emissions. Report scope 502 can also be set to include subcategories of top-level emissions scopes. Reports can further be configured based on meeting application used to host virtual meetings.

Referring now to FIGS. 5B, an example of emissions report 500B is shown, in accordance with various embodiments. Emission report 500B can include basic information 504 about entity 101 or a user authenticated to meeting server 528 or carbon accounting server 530. Emissions report 500B can include emissions data associated with entity 101 and retrieved from emissions accounting server 530 in response to a reporting request. Reporting requests can come from reporting interface 500, for example, or can be automatically triggered by a reporting schedule or configurable reporting settings. In various embodiments, report 500B may include basic information such as a name of entity 101, a primary place of business or headquarters location, industry type, reporting period, report scope, or other basic identifying information for report 500B.

In various embodiments, emission report 500B may flag missing data 506. Missing data 506 can be data expected within scope 502 of the report but not present in data retrieved from emissions accounting server 530. Types of missing data 506 can include top-level categories (e.g., scope 1, scope 2, scope 3, meetings) or subcategories (e.g., stationary combustion, mobile combustion, fugitive emissions, process emissions, electricity, water, heat, ZOOM, TEAMS, MEET, groupings within entity 101, missing periods, or other identifiable categories of data). Missing data 506 flags can indicate to entity 101 that a check should be made for missing data to validate report 500B.

In various embodiments, report 500B can include emissions data 508. Emissions data 508 can be sorted by scope 502 categories. In the examples of FIG. 5B, scope 1 data is shown, though other embodiments could include meeting emissions data, scope 2 emissions data, or other emissions data.

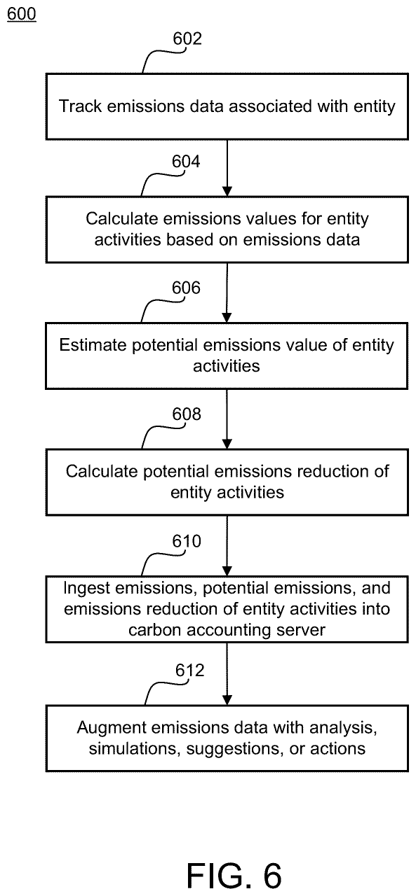

Referring now to FIG. 6, an example process 600 is shown for assessing emissions of individuals and activities associated with entity 101 (of FIG. 1), in accordance with various embodiments. Process 600 may begin by tracking emissions data of individuals and activities associated with entity 101 (Block 602). The tracked emissions data can be collected using techniques described above or using any other technique suitable for collecting raw data related to activities of entity 101.

In various embodiments, emissions values may be calculated for entity activities based on the collected emissions data (Block 604). Emissions values may be calculated for each activity or individual associated with entity 101. Emissions values may also be aggregated into groups of activities or individuals associated with entity 101. Emissions values may accurately represent or estimate the actual emissions associated with the individuals and activities of entity 101.

In various embodiments, process 600 may include estimating potential emissions values of activities and individuals associated with entity 101 (Block 606). Potential emissions values can comprise baseline values for similarly situated entities (e.g., performing the same activities in the same regions, operating in the same industries, having similar footprints, etc.). Baseline values can be typical, average, or median emissions values for similarly situated entities. Potential emissions values can also be emissions values of entity 101 likely to be realized if entity 101 changes behavior. Potential emissions values can be determined by simulating emissions from activities and individuals associated with entity 101. Potential emissions values can be calculated using actual emissions values from similarly situated entities that made similar changes. Potential emissions values can be calculated in response to changes proposed by entity 101 in activities or individuals associated with entity 101. The potential emissions value used for a given activity or individual can determine the type of reduction data generated for entity 101.

In various embodiments, potential emissions values can be determined by taking into consideration reasonable factors unspecified by the entity, or known factors associated with the entity. For example, a reasonable travel itinerary for an event can be based in part on duration of the event, location of the event, and scope of the event. For example, for most 30-minute meetings, a flight across the Atlantic Ocean might be considered unreasonable when the attendee could accomplish the meeting goals telephonically or virtually. However, a brief drive across town might be reasonable for the same 30-minute meeting. In some examples, a cumulative activity assessment may be used to determine whether a flight would be reasonably included in a travel itinerary for an individual attendee.

In the example of FIG. 6, process 600 includes calculated potential emissions reductions of activities and individuals associated with entity 101 (Block 608), in accordance with various embodiments. The potential emissions reductions can be an estimate of actual emissions reductions where the potential emissions value used is a baseline value for the associated activities or individuals. The emission reduction or emission savings of each individual associated with entity 101 can be the difference between the individual's actual emissions value and the individual's potential emissions value. Emissions reductions for an activity can be calculated by summing the emissions reduction of individual attendees along with any broader emissions associated with the activity but not attributable to a single individual (e.g., emissions from running the lights and heat at a venue). The actual emissions, the potential emissions, and the potential emissions reduction for individuals participating in an activity, and for the broader activity, can be calculated at by client devices 102, server 120, or carbon accounting server 330.

For example, if a company hosted a relatively green event with an emissions value of 36.3 kg of CO₂, and similarly situated entities would typically emit 41.8 kg of CO₂, then the emission reduction of the company may be the difference between the emissions value and the potential emissions value (i.e., 411.8−361.3=50.5 kg of CO₂). The company in the example would have prevented the emission of 50.5 kg of CO₂ relative to similarly situated companies hosting similar events.

In various embodiments, the potential emissions value can be a value representing a company's emissions if they make a policy change. For example, if the company changes its transportation policy to require that employees walk or use public transit for all company business rather than the use of individual automobiles. The potential emissions value can be calculated for each individual trip logged over the past 6 months by determining the CO₂ emissions of walking for trips under 1 mile and using public transit for longer trips. The potential emissions value for each trip over the past 6 months can then be compared to the actual emissions value over the last 6 months to determine potential emissions reduction over the period. The potential emissions reduction may be calculated for single activities and individuals for the past 6 months, then aggregated to determine the company's potential emissions savings by the policy change. The potential emissions reduction may be calculated for all activities and individuals for the past 6 months at once, by aggregating the emissions values and aggregating the potential emissions values then calculating the difference, to determine the company's potential emissions savings by the policy change.

Various embodiments of process 600 may ingest raw emissions data, calculated emissions values, calculated potential emissions values, and calculated potential emissions reductions of individuals and activities associated with entity 101 into carbon accounting server 330 (Block 610). The actual emissions, potential emissions, and potential emissions reduction values can be processed at regular intervals or on demand to generate reports or interfaces described herein. In some examples, notifications are automatically sent to an admin account in response to threshold emissions values being hit by individuals, teams, or across an enterprise. Some embodiments can send messages to individuals or teams recommending conservation techniques for meetings such as holding more meetings virtually, reducing heating temperatures, mandating cleaner modes of transportation, or other changes that can reduce the emissions of entity 101.

In various embodiments, system 100 can augment emissions data (Block 612) with analysis, simulations, suggestions, or actions. AI 123 can be trained and applied to analyze emissions data for potential emissions savings opportunities. AI 123 can run simulations to determine the emissions cost or savings of changes to behavior in entity 101. AI 123 can make suggestions for behavior modification, for organizational configuration, or organization-wide or group-wide policies that can save emissions for the entity. AI 123 can compare entity 101 to similarly situated peers to identify changes that can improve emissions and areas where entity 101 is ahead of its nearest competitors in saving emissions. In some examples, AI 123 can take actions by directly modifying configurations available over network 106, entity requirements for employees to take actions, implementing suggestion screens for employees and affiliated entities during actions, or otherwise acting within limitations to reduce emissions of entity 101.

Systems of the present disclosure may educate and inform users and entities about their CO2 emissions, reduction methods of CO2 emissions and other CO2 emission possibilities. Recommendations or policy changes can be made in real time or near real time. Systems described herein tend to improve carbon emissions savings from entities 101 based on activities and individuals associated the entities. Carbon accounting integration automates emissions tracking for activities associated with entity 101 and can generate reports on demand or on a regular schedule. AI augmentation can generate business intelligence or otherwise take action to improve emissions savings for scope 1, scope 2, and scope 3 emissions of the entity based the entity's own emissions data.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the invention is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Devices, systems, and methods are provided herein. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or device that comprises a list of elements does not include only those elements but may include other elements not expressly listed or inherent to such process, method, article, or device.

What is claimed is:

1. An automated process, comprising:
collecting, by a computer-based system, supply-chain data of an entity, wherein the supply-chain data comprises shipping data and manufacturing data of a product offered by the entity;
calculating, by the computer-based system, a supply-chain emissions value of the product based on the shipping data and the manufacturing data of the product;
estimating, by the computer-based system, a potential emissions value of the product using potential shipping data and potential manufacturing data, wherein the potential shipping data is generated based on a first potential policy change of the entity, wherein the manufacturing data is based on a second potential policy change of the entity;
calculating, by the computer-based system, a potential emissions reduction of the entity by subtracting the potential emissions value of the product from the supply-chain emissions value of the product; and
ingesting, by the computer-based system, the supply-chain emissions value of the product, the potential emissions value, and the potential emissions reduction into a carbon accounting database accessible by the entity.

2. The automated process of claim 1, further comprising generating a carbon emissions report for the entity, wherein the carbon emissions report includes the supply-chain emissions value of the product, the potential emissions value of the product, and the potential emissions reduction.

3. The automated process of claim 1, further comprising hosting an emissions interface comprising a graphical representation of actual emissions values from a plurality of products offered by the entity, wherein the products include the product.

4. The automated process of claim 1, further comprising aggregating a plurality products into a group comprising a grouped supply-chain emissions value, a grouped potential emissions value, and a grouped potential emissions reduction over a predetermined period.

5. The automated process of claim 4, further comprising hosting an emissions interface comprising a graphical representation of the group including the grouped supply-chain emissions value, the grouped potential emissions value, and the grouped potential emissions reduction over the predetermined period.

6. The automated process of claim 1, wherein the carbon accounting database further comprises scope 1 emissions data and scope 2 emissions data associated with the entity.

7. The automated process of claim 6, further comprising hosting a reporting interface to selectively generate an emissions report comprising the scope 1 emissions data, the scope 2 emissions data, and the supply-chain emissions value.

8. A computer-based system, comprising:
a processor; and
a tangible, non-transitory memory configured to communicate with the processor, the tangible, non-transitory memory having instructions stored thereon that, in response to execution by the processor, cause the computer-based system to perform operations comprising:
collecting, by the computer-based system, supply-chain data of an entity, wherein the supply-chain data comprises shipping data and manufacturing data of a product offered by the entity;
calculating, by the computer-based system, a supply-chain emissions value of the product based on the shipping data and the manufacturing data of the product;
estimating, by the computer-based system, a potential emissions value of the product using potential shipping data and potential manufacturing data, wherein the potential shipping data is generated based on a first potential policy change of the entity, wherein the manufacturing data is based on a second potential policy change of the entity;
calculating, by the computer-based system, a potential emissions reduction of the entity by subtracting the potential emissions value of the product from the supply-chain emissions value of the product; and
ingesting, by the computer-based system, the supply-chain emissions value of the product, the potential emissions value, and the potential emissions reduction into a carbon accounting database accessible by the entity.

9. The computer-based system of claim 8, wherein the operations further comprise generating a carbon emissions report for the entity, wherein the carbon emissions report includes the supply-chain emissions value of the product, the potential emissions value of the product, and the potential emissions reduction.

10. The computer-based system of claim 8, wherein the operations further comprise hosting an emissions interface comprising a graphical representation of actual emissions values from a plurality of products offered by the entity, wherein the products include the product.

11. The computer-based system of claim 8, wherein the operations further comprise aggregating a plurality products into a group comprising a grouped supply-chain emissions value, a grouped potential emissions value, and a grouped potential emissions reduction over a predetermined period.

12. The computer-based system of claim 11, wherein the operations further comprise hosting an emissions interface comprising a graphical representation of the group including the grouped supply-chain emissions value, the grouped potential emissions value, and the grouped potential emissions reduction over the predetermined period.

13. The computer-based system of claim 8, wherein the carbon accounting database further comprises scope 1 emissions data and scope 2 emissions data associated with the entity.

14. The computer-based system of claim 13, wherein the operations further comprise hosting a reporting interface to selectively generate an emissions report comprising the scope 1 emissions data, the scope 2 emissions data, and the supply-chain emissions value.

15. An article of manufacture including a non-transitory, tangible computer readable storage medium having instructions stored thereon that, in response to execution by a computer-based system, cause the computer-based system to perform operations, the operations comprising:
collecting, by the computer-based system, supply-chain data of an entity, wherein the supply-chain data comprises shipping data and manufacturing data of a product offered by the entity;
calculating, by the computer-based system, a supply-chain emissions value of the product based on the shipping data and the manufacturing data of the product;
estimating, by the computer-based system, a potential emissions value of the product using potential shipping data and potential manufacturing data, wherein the potential shipping data is generated based on a first potential policy change of the entity, wherein the manufacturing data is based on a second potential policy change of the entity;
calculating, by the computer-based system, a potential emissions reduction of the entity by subtracting the potential emissions value of the product from the supply-chain emissions value of the product; and
ingesting, by the computer-based system, the supply-chain emissions value of the product, the potential emissions value, and the potential emissions reduction into a carbon accounting database accessible by the entity.

16. The article of claim 15, wherein the operations further comprise generating a carbon emissions report for the entity, wherein the carbon emissions report includes the supply-chain emissions value of the product, the potential emissions value of the product, and the potential emissions reduction.

17. The article of claim 15, wherein the operations further comprise hosting an emissions interface comprising a graphical representation of actual emissions values from a plurality of products offered by the entity, wherein the products include the product.

18. The article of claim 15, wherein the operations further comprise aggregating a plurality products into a group comprising a grouped supply-chain emissions value, a grouped potential emissions value, and a grouped potential emissions reduction over a predetermined period.

19. The article of claim 15, wherein the carbon accounting database further comprises scope 1 emissions data and scope 2 emissions data associated with the entity.

20. The article of claim 19, wherein the operations further comprise hosting a reporting interface to selectively generate an emissions report comprising the scope 1 emissions data, the scope 2 emissions data, and the supply-chain emissions value.
